(19) United States
(12) Patent Application Publication
(10) Pub. No.: US 2026/0281156 A1
(43) Pub. Date: Sep. 17, 2026

(54) SYSTEM AND A METHOD FOR DETECTING PHISHING WEB PAGES

(71) Applicant: GROUP-IB GLOBAL PRIVATE LIMITED, SINGAPORE (SG)

(72) Inventor: Aleksandr ISAEV, Phuket (TH)

(21) Appl. No.: 19/176,903

(22) Filed: Apr. 11, 2025

(30) Foreign Application Priority Data
Mar. 14, 2025 (SG) 10202500659R

(51) Int. Cl. H04L 9/40

(52) U.S. Cl. CPC H04L 63/1483; H04L 63/1416

(57) ABSTRACT

A method and an electronic device for detecting phishing web pages are provided. The method comprises: during a training phase: receiving a plurality of training web pages; generating, based on the HTML code of a given training web page of the plurality of training web pages, a respective training vector, generating, based on the respective training vector, a respective tokenized training vector associated with the given training web page; generating a plurality of training digital objects, a given one of which includes: (i) the respective tokenized training vector associated with the given training web page; and (ii) a respective label representative of whether the given training web page is a phishing web page or not; and feeding each one of the plurality of training digital objects to a neural network for training the neural network to determine whether a given in-use web page is a phishing web page or not.

### CROSS-REFERENCE

The present application claim priority to a Singaporean Patent Application No.: 10202500659R, filed with Intellectual Property Office of Singapore on Mar. 14, 2025, the content of which is incorporated herein by reference in its entirety.

### FIELD

The present technology relates broadly to the field of cybersecurity, and, in particular, to a method and a system for detection of phishing web pages.

### BACKGROUND

One of the most widespread types of cybercrime is phishing. Usually, technical means used by intruders for this purpose are rather simple and do not require any special knowledge. Phishing attacks can be executed using so-called “phishing kits”, i.e., kits of malicious web pages that mimic legitimate web sites of organizations; they are offered for sale at numerous closed web forums used by the intruders.

Usually, these phishing pages are created according to a template, their structure at the level of HTML code is identical or very similar. Further, they are hosted on different servers, while the pages themselves are assigned the respective web address and located at different IP addresses.

Certain prior art approaches have been proposed for automatic detection of such web pages.

U.S. Pat. No. 9,356,947-B2, issued on May 31, 2016, assigned to Opsec Online Ltd., and entitled “METHODS AND SYSTEMS FOR ANALYZING DATA RELATED TO POSSIBLE ONLINE FRAUD,” discloses methods, systems and software for analyzing data. In particular embodiments, for example, a set of data about a web site may be analyzed to determine whether the web site is likely to be illegitimate (e.g., to be involved in a fraudulent scheme, such as a phishing scheme, the sale of gray market goods, etc.). In an exemplary embodiment, a set of data may be divided into a plurality of components (each of which, in some cases, may be considered a separate data set). Merely by way of example, a set of data may comprise data gathered from a plurality of data sources, and/or each component may comprise data gathered from one of the plurality of data source. As another example, a set of data may comprise a document with a plurality of sections, and each component may comprise one of the plurality of sections.

U.S. Pat. No. 11,336,689-B1, issued on May 17, 2022, assigned to Netskope Inc., and entitled “DETECTING PHISHING WEBSITES VIA A MACHINE LEARNING-BASED SYSTEM USING URL FEATURE HASHES, HTML ENCODINGS AND EMBEDDED IMAGES OF CONTENT PAGES,” discloses a classifier that classifies a URL and content page accessed via the URL as phishing or not, with URL feature hasher that parses and hashes the URL to produce feature hashes, and headless browser to access and internally render a content page at the URL, extract HTML tokens, and capture an image of the rendering. Also disclosed are an HTML encoder, trained on HTML tokens extracted from pages at URLs, encoded, then decoded to reproduce images captured from rendering, that produces an HTML encoding of the tokens extracted, and an image embedder, pretrained on images, that produces an image embedding of the image captured. Further, phishing classifier layers, trained on the feature hashes, the HTML encoding, and the image embedding, process the URL feature hashes, HTML encoding and image embeddings to produce a likelihood score that the URL and the page accessed presents a phishing risk.

### SUMMARY

It is an object of the present technology to ameliorate at least inconveniences associated with the prior art.

Unlike the prior art solutions reviewed above that require numerous items of different data types: the URL, IP address, domain name, a screenshot of the page of interest, features retrieved from words of the page text, at least some non-limiting embodiments of the present technology allow using the HTML code of a given web page for classifying the given web page as being a phishing or non-phishing web page.

More specifically, in accordance with a first broad aspect of the present technology, there is provided a computer-implemented method for detecting phishing web pages. The method is executable by a computing device including at least one processor. The method comprises: during a training phase: receiving a plurality of training web pages; analyzing each one of the plurality of training web pages to delete, from a Hypertext Markup Language (HTML) code thereof, data that has no influence on a corresponding HTML structure of the plurality of training web pages; generating, based on the HTML code of a given training web page of the plurality of training web pages, a respective training vector, the respective training vector including a plurality of tags defining the corresponding HTML structure of the given training web page; deleting repeated tags from the respective training vector associated with the given training web page; replacing remaining tags in the respective training vector with respective numerical tokens, thereby generating a respective tokenized training vector associated with the given training web page; generating a training set of data including a plurality of training digital objects, a given one of which includes: (i) the respective tokenized training vector associated with the given training web page; and (ii) a respective label representative of whether the given training web page is a phishing web page or not; feeding each one of the plurality of training digital objects to a neural network for training the neural network to determine whether a given in-use web page is a phishing web page or not. Further, during an in-use phase, following the training phase, the method comprises: receiving the given in-use web page; analyzing the given in-use web page to delete, from the HTML code thereof, data that has no influence on the corresponding HTML structure of the given in-use web page; generating, based on the HTML code of the given in-use web page, a respective in-use vector; deleting repeated tags from the respective in-use vector; replacing remaining tags in the respective in-use vector with the respective numerical tokens, thereby generating a respective tokenized in-use vector associated with the given in-use web page; feeding the respective tokenized in-use vector to the trained neural network, thereby causing the neural network to generate a likelihood value representative of the given in-use web page being a phishing web page; and in response to the likelihood value exceeding a predetermined likelihood threshold value: determining that the given in-use web page is a phishing web page; and determining a responsive action to the phishing web page.

In some implementation of the method, the data that has no influence on the HTML structure includes at least one selected from the group consisting of: mandatory tags that are present in the HTML code of every web page; metadata including content of the given training web page that is not represented by the HTML code; attributes including additional parameters that are arranged within angle brackets; and embedded tags.

In some implementation of the method, each numerical token is an integer number.

In some implementations of the method, during the training phase, the method further comprises: determining, for each tokenized training vector of a respective phishing training web page of the plurality of training web pages, a respective value of a difference metric from respective tokenized training vectors of non-phishing training web pages of the plurality of training pages; identifying, among tokenized training vectors of phishing training web page, based on respective values of the difference metric, unstable tokenized training vectors; and removing, from the plurality of training digital objects, training digital objects including the unstable tokenized training vectors, thereby generating a refined plurality of training digital objects.

In some implementation of the method, the identifying the unstable tokenized training vectors comprises identifying those tokenized training vectors of phishing training web pages of the plurality of training webpages that are associated with respective values of the difference metric that are no greater than a predetermined difference threshold value.

In some implementation of the method, the difference metric is based on a cosine similarity.

In some implementation of the method, the difference metric is based on a Levenshtein distance.

In some implementation of the method, the difference metric is based on a Damerau-Levenshtein distance.

In some implementation of the method, during the in-use phase, prior to the feeding the respective tokenized in-use vector to the trained neural network, the method further comprises: determining a respective value of a similarity metric between the respective tokenized in-use vector and each training tokenized vector in the refined plurality of training digital objects; and in response to a maximum value among respective values of the similarity metric exceeding a predetermined similarity threshold value, determining that the given in-use web page is a phishing web page.

In some implementations of the method, the similarity metric is based on one selected from the group consisting of: a cosine similarity, a Levenshtein distance, and a Damerau-Levenshtein distance.

In some implementation of the method, the neural network is a Long Short-Term Memory (LSTM) neural network.

In some implementation of the method, the neural network is a Gated Recurrent Unit (GRU) neural network.

In some implementation of the method, the responsive action to the phishing web page includes at least one selected from the group consisting of: compiling and sending a complaint to a hosting provider associated with the phishing web page; compiling and sending a complaint to a domain registrar associated with the phishing web page; compiling a warning notification to cybersecurity personnel; outputting, in a browser window executed by the computing device, a warning notification that the given in-use web page is the phishing page; and storing the phishing web page in a database of phishing pages.

Further, in accordance with a second broad aspect of the present technology, there is provided a computing device for detecting of phishing web pages. The computing device comprising at least one processor and at least one non-transitory computer-readable medium storing instructions, which, when executed by the at least one processor, cause the computing device to execute, during a training phase: receiving a plurality of training web pages; analyzing each one of the plurality of training web pages to delete, from a Hypertext Markup Language (HTML) code thereof, data that has no influence on a corresponding HTML structure of the plurality of training web pages; generating, based on the HTML code of a given training web page of the plurality of training web pages, a respective training vector, the respective training vector including a plurality of tags defining the corresponding HTML structure of the given training web page; deleting repeated tags from the respective training vector associated with the given training web page; replacing remaining tags in the respective training vector with respective numerical tokens, thereby generating a respective tokenized training vector associated with the given training web page; generating a training set of data including a plurality of training digital objects, a given one of which includes: (i) the respective tokenized training vector associated with the given training web page; and (ii) a respective label representative of whether the given training web page is a phishing web page or not; feeding each one of the plurality of training digital objects to a neural network for training the neural network to determine whether a given in-use web page is a phishing web page or not. Further, during an in-use phase, following the training phase, the instructions cause the computing device to execute: receiving the given in-use web page; analyzing the given in-use web page to delete, from the HTML code thereof, data that has no influence on the corresponding HTML structure of the given in-use web page; generating, based on the HTML code of the given in-use web page, a respective in-use vector; deleting repeated tags from the respective in-use vector; replacing remaining tags in the respective in-use vector with the respective numerical tokens, thereby generating a respective tokenized in-use vector associated with the given in-use web page; feeding the respective tokenized in-use vector to the trained neural network, thereby causing the neural network to generate a likelihood value representative of the given in-use web page being a phishing web page; and in response to the likelihood value exceeding a predetermined likelihood threshold value: determining that the given in-use web page is a phishing web page; and determining a responsive action to the phishing web page.

In some implementations of the computing device, the instructions further cause the computing device to execute: determining, for each tokenized training vector of a respective phishing training web page of the plurality of training web pages, a respective value of a difference metric from respective tokenized training vectors of non-phishing training web pages of the plurality of training pages; identifying, among tokenized training vectors of phishing training web page, based on respective values of the difference metric, unstable tokenized training vectors; and removing, from the plurality of training digital objects, training digital objects including the unstable tokenized training vectors.

In the context of the present specification, unless expressly provided otherwise, a computer system may refer, but is not limited, to an “electronic device”, an “operation system”, a “system”, a “computer-based system”, a “controller unit”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, a “database” is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

### BRIEF DESCRIPTION OF THE DRAWINGS

For a better understanding of the non-limiting embodiments of the present technology, as well as other aspects and further features thereof, reference is made to the following description which is to be used in conjunction with the accompanying drawings, where:

FIG. 1 depicts a flowchart diagram of a training phase of the present method for detecting phishing web pages, in accordance with certain non-limiting embodiments of the present technology;

FIG. 2 depicts a flowchart diagram of an in-use phase of the present method for detecting phishing web pages, in accordance with certain non-limiting embodiments of the present technology;

FIG. 3A schematically depicts an example HTML code of a given web page, in accordance with certain non-limiting embodiments of the present technology;

FIG. 3B schematically depicts the example HTML code of FIG. 3A with metadata being deleted therefrom, in accordance with certain non-limiting embodiments of the present technology;

FIG. 3C schematically depicts a vector generated based on the HTML code associated with the given web page of FIG. 3B, in accordance with certain non-limiting embodiments of the present technology;

FIG. 3D schematically depicts the vector of FIG. 3C with repeated tags being deleted, in accordance with certain non-limiting embodiments of the present technology;

FIG. 3E schematically depicts the vector of FIG. 3D, tags of which have been tokenized, in accordance with certain non-limiting embodiments of the present technology; and

FIG. 4 depicts a schematic diagram of a computing environment that can be used for executing the training and in-use phases of FIGS. 1 and 2, respectively, in accordance with certain non-limiting embodiments of the present technology.

### DETAILED DESCRIPTION

The following detailed description is provided to enable any one skilled in the art to implement and use the non-limiting embodiments of the present technology. Specific details are provided merely for descriptive purposes and to give insights into the present technology, and no was as a limitation. However, it would be apparent for the person skilled in the art that some of these specific details may not be necessary to implement certain non-limiting embodiments of the present technology. The descriptions of specific implementations are only provided as representative examples. Various modifications of these embodiments may become apparent to the person skilled in the art; the general principles defined in this document may be applied to other non-limiting embodiments and implementations without departing from the scope of the present technology.

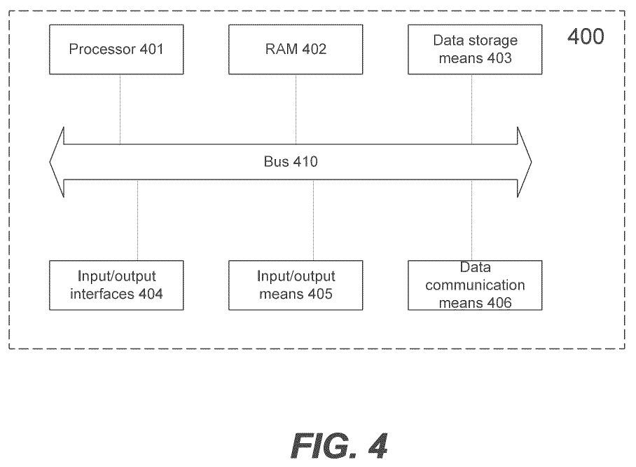

Certain non-limiting embodiments of the present technology are directed to systems and methods for detecting phishing web pages. According to certain non-limiting embodiments of the present technology, the present method for detecting phishing web pages comprises a training phase, during which a machine-learning algorithm (MLA) is trained to determine whether a given web page is phishing or not; and an in-use phase, during which the trained MLA is used to determine whether the given web page is phishing. According to certain non-limiting embodiments of the present technology, the present method can be executed by a processor of a computing device, such as a processor 401 of a computing environment 400 described below with reference to FIG. 4. It is not limited how the computing device is implemented and can include, without limitation, a smartphone, a laptop, a tablet computer, or a personal computer. To that end, the computing device can include some of all components of the computing environment 400.

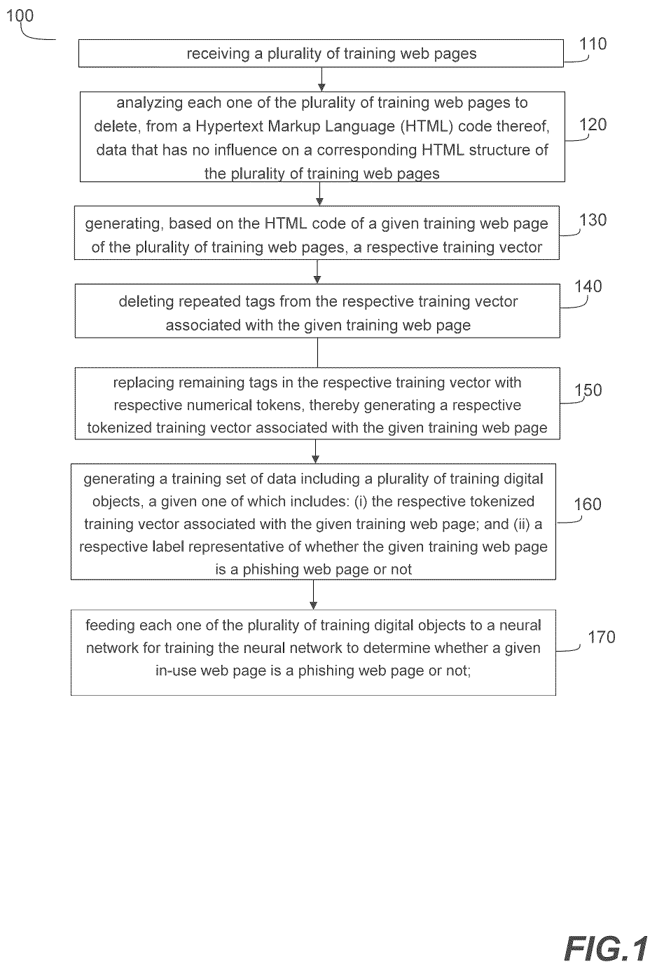

With the initial reference to FIG. 1, there is depicted a flowchart diagram of a training phase 100 of the present method, in accordance with certain non-limiting embodiments of the present technology. As mentioned above, the training phase 100 can be executed by the processor 401 of the computing device.

### Step 110: Receiving a Plurality of Training Web Pages

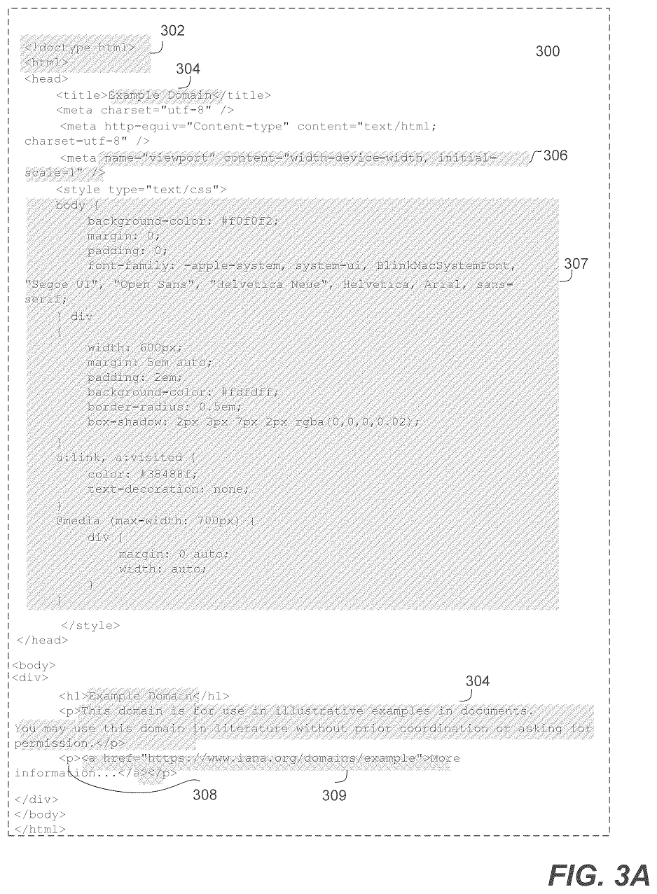

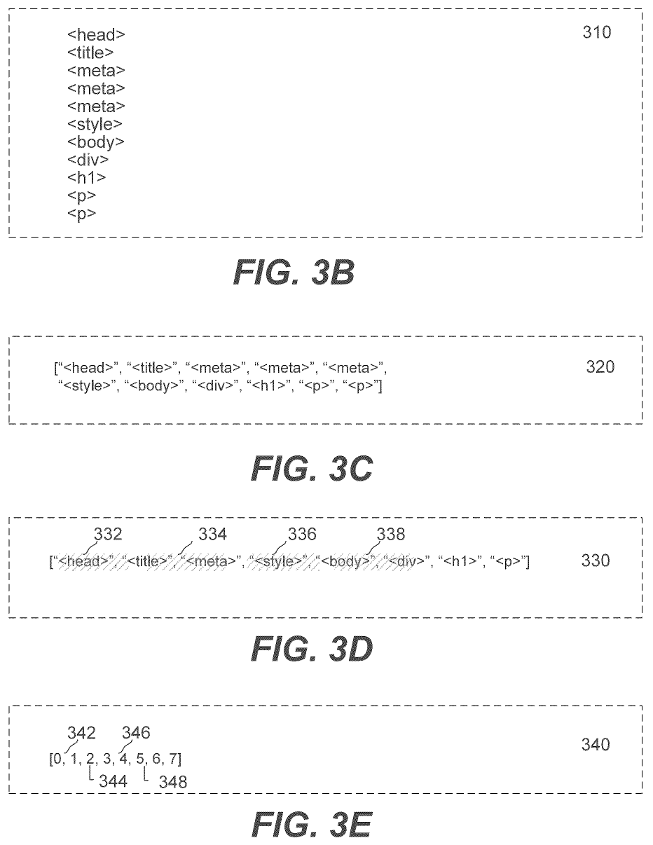

The training phase (100) starts at step (110) with the processor 401 of the computing device being configured to receive a plurality of training web pages. According to certain non-limiting embodiments of the present technology, each training web page of the plurality of training web pages can be preliminarily marked with a respective label, representative of a given training web page (such as a training web page 307, an HTML code of which is schematically depicted in FIG. 3A) being either phishing or non-phishing. It should be noted that, to this end, a device that implements the method must be connectable to a computing network, e.g., to the Internet.

The training web pages are intentionally designed to be phishing web pages, as well as, separately, non-phishing web pages. According to certain non-limiting embodiments of the present technology, assigning the respective label to the given training web page may be executed by human operators. In other non-limiting embodiments of the present technology, the assigning the respective label may be performed by a trained system that has been similarly trained to the below-described system.

The received training web pages are saved in the storage 403. The training phase 100 hence advances to step 120.

Step 120: Analyzing Each One of the Plurality of Training Web Pages to Delete, from a Hypertext Markup Language (HTML) Code Thereof, Data that has No Influence on a Corresponding HTML Structure of the Plurality of Training Web Pages

At step (120), according to certain non-limiting embodiments of the present technology, the processor 401 can be configured to delete, from the HTML code of the given training web page, data that has no influence on the HTML structure thereof. With reference to FIG. 3A, there is schematically depicted an example HTML code (300) of the training web page 307, in accordance with certain non-limiting embodiments of the present technology. More specifically, in some non-limiting embodiments of the present technology, the processor 401 can be configured to delete from the HTML code of the training web page 307 at least one of the pieces of data:
mandatory tags, such as HTML or DOCTYPE (302) that are present within the code of the majority of web page.
metadata, i.e., the entire content of the web page that is not HTML code, e.g., text located thereon such as text (304), or style instructions that describe formatting of a visual appearance of the training web page (307).
attributes, i.e., additional parameters, that are located within angled brackets along with the tag itself, such as attributes (306) of one of the META tags, as examples.
embedded tags, i.e., such as, e.g., a tag A (309). It is embedded relative to an other tag P (308), thus, it does not comprise any information about the structure of the web page being analyzed.

How the processor 401 is configured to delete this data that has no influence on the HTML structure is not limited. For example, to do so, the processor 401 can be configured to execute a preliminarily prepared script. After the HTML code 300 illustrated in FIG. 3A is processed at step (120), it will acquire the form of a refined HTML code 308 of the training web page 307, schematically illustrated in FIG. 3B, in accordance with certain non-limiting embodiments of the present technology. Further, the processor 401 can be configured to save the refined HTML code 308 in the storage 403.

The training phase 100 hence advances to step 130.

### Step 130: Generating, Based on the HTML Code of a Given Training Web Page of the Plurality of Training Web Pages, a Respective Training Vector

At step (130), according to certain non-limiting embodiments of the present technology, the processor 401 can be configured to generate, based on the refined HTML code 308 of the training web page 307, a training vector 320, schematically illustrated in FIG. 3C, in accordance with certain non-limiting embodiments of the present technology. As it can be appreciated, the training vector 320 includes tags of the refined HTML code 308 associated with the training web page 307. To generate the respective training vector for each training web page of the plurality of web pages, the processor 401 can be configured to execute a preliminarily prepared script. Further, the processor 401 can be configured to save the respective training vectors, for example, in a storage 403 of the computing device.

The training phase 100 hence advances to step 140.

Step 140: Deleting Repeated Tags from the Respective Training Vector Associated with the Given Training Web Page

At step (140), according to certain non-limiting embodiments of the present technology, the processor 401 can be configured to delete repeated tags from the training vector 320, thereby generating a refined training vector 330, schematically depicted in FIG. 3D, in accordance with certain non-limiting embodiments of the present technology. For example, to do so, the processor 401 can be configured to execute a pre-configured script having an algorithm that performs search and deletion of repetitions within the training vector 320. Further, the processor 401 can be configured to store the refined training vector 330 in the storage 403.

The training phase 100 hence advances to step 150.

Step 150: Replacing Remaining Tags in the Respective Training Vector with Respective Numerical Tokens, Thereby Generating a Respective Tokenized Training Vector Associated with the Given Training Web Page

At step (150), according to certain non-limiting embodiments of the present technology, the processor 401 can be configured to replace the tags of the refined training vector 330 that are remaining after deleting the repeated tags in the training vector 320 with numerical tokens. According to certain non-limiting embodiments of the present technology, the tokens can be positive integers. It is not limited how the processor 401 is configured to assign a given tokens to a respective tag of the refined training vector 330.

For example, and in no way as a limitation, the first tag of the refined training vector 330, such as a HEAD tag (332), as schematically depicted in FIG. 3D, may be assigned with a first numerical token (342), which can be ‘0’. Further, a TITLE tag (334) may be assigned a second numerical token (334), which can have the value of ‘1’; a META tag (336) may be a third numerical token (346), which can be ‘2’; a STYLE tag (338) may be assigned with a third numerical value (348), which can be ‘3’; and so on. By doing so, the processor 401 can be configured to generate tokenized training vectors for each one of the plurality of training web pages, such as a tokenized training vector 340 for the training web page 307.

Further, the processor 401 can be configured to save, in the storage 403, the respective tokenized vectors that correspond to phishing and secure training web pages in different database partitions or different folders.

The training phase 100 hence advances to step 160.

Step 160: Generating a Training Set of Data Including a Plurality of Training Digital Objects, a Given One of which Includes: (I) the Respective Tokenized Training Vector Associated with the Given Training Web Page; and (II) a Respective Label Representative of Whether the Given Training Web Page is a Phishing Web Page or not

At step 160, according to certain non-limiting embodiments of the present technology, the processor 401 can be configured to generate a training set of data. The training set of data includes a plurality of training digital objects, a given one of which includes, for the training web page 307: (1) the tokenized training vector 340 associated with the training web page 307; and (2) the respective label indicative of whether the training web page 307 is phishing or non-phishing.

The training phase 100 hence advances to step 170.

Step 170: Feeding Each One of the Plurality of Training Digital Objects to a Neural Network for Training the Neural Network to Determine Whether a Given in-Use Web Page is a Phishing Web Page or not

At step 170, according to certain non-limiting embodiments of the present technology, the processor 401 can be configured to use the training set of data, generated at step 160, to train a neural network to determine whether a given in-use web page is phishing or non-phishing.

In some non-limiting embodiments of the present technology, the neural network can comprise a Long Short-Term Memory (LSTM) neural network. In other non-limiting embodiments of the present technology, the neural network can Gated Recurrent Unit (GRU) neural network.

To train the neural network, the processor 401 can be configured to feed, during a respective training iteration, the given training digital object of the plurality of training digital objects to the neural network, thereby causing the neural network to generate a respective intermediate prediction value indicative of whether the training web page 307 is phishing or not. Further, the processor 401 can be configured to determine a difference between the respective intermediate prediction value and the respective label, which can be expressed by a loss function (such as a Cross-Entropy loss function). The processor 401 can be configured to minimize the loss function at each training iteration, thereby training the neural network to determine whether the given in-use web page is phishing or non-phishing (secure).

According to certain non-limiting embodiments of the present technology, the processor 401 can be configured to continue training the neural network until a predetermined criterion is met. In some non-limiting embodiments of the present technology, the predetermined criterion may include numbers of False Positive (FP) and False Negative (FN) predictions of the neural network being no greater than respective predetermined threshold. For example, the predetermined criterion can include these numbers being less than the following values:

FP<0.1%

FN<20%.

In other non-limiting embodiments of the present technology, the processor 401 can be configured to continue training the neural network until the numbers of False Positives and False Negatives predictions achieve the respective predetermined threshold values.

Thus, the processor 401 can be configured to train the neural network to generate, for the given in-use web page, a probability that the given in-use web page is a phishing web page and a probability that the web page is not a phishing page.

The decision of the trained neural network may be an estimated probability P that the given in-use web page belongs to either type of the training web pages, that is, whether phishing or non-phishing. For example, the decision for the given in-use web page may look like Pm=0.7, Pl=0.3, meaning that the probability value that this web page is malicious (phishing) is 0.7 and the probability value that this web page is legitimate (non-phishing) is 0.3.

Optionally, at step 170, according to certain non-limiting embodiments of the present technology, the processor 401 can further be configured to identify and remove from the plurality of training digital objects those digital objects that include unstable tokenized training vectors, representative of phishing training web pages. In the context of the present specification, the term “unstable tokenized training vector” denotes a tokenized training vector, associated with a respective phishing web page, that has an insignificant difference as compared to tokenized training vectors that correspond to secure (non-phishing) training web pages.

To identify the training digital objects including unstable tokenized training vectors, according to certain non-limiting embodiments of the present technology, the processor 401 can be configured to determine, for a given tokenized training vector associated with the respective phishing training web page, respective values of a difference metric between the given tokenized training vector and each tokenized training vector associated with the non-phishing training web pages. Further, the processor 401 can be configured to: (i) compare the respective value of the difference metric associated with the given tokenized training vector to a predetermined difference threshold value (such as 0.9, as an example); and (ii) in response to at least one respective value between the given tokenized training vector, associated with the respective phishing training web page, and the respective tokenized training vector, associated with a respective non-phishing web page, being lower than the predetermined difference threshold value, identify the given tokenized training vector associated with the respective phishing training web page as being an unstable tokenized training vector.

In various non-limiting embodiments of the present technology, the difference metric can be based on one of: a cosine similarity, a Levenshtein distance, and a Damerau-Levenshtein distance. It should be expressly understood that use of other vector difference metrics is also envisioned without departing from the scope of the present technology. How the processor 401 is configured to determine values of the difference metric is also not limited and can include, for example, executing a preliminarily prepared script or using FAISS library.

After identifying the unstable tokenized training vectors, in some non-limiting embodiments of the present technology, the processor 401 can be configured to delete training digital objects associated with these tokenized training vectors from the plurality of training digital objects, thereby generating a refined plurality of training digital objects.

It should be expressly understood that the above-described sub-step for generating the refined plurality of training digital objects is optional and can be executed under certain circumstances, such as situations associated with limited computational resources of the computing environment 400. Also, in these embodiments where the processor 401 is configured to remove the training digital objects including the unstable tokenized vectors during the training phase 100, the processor 401 can further be configured to store the remaining training digital objects, that is, the refined plurality of training digital objects, in a separate database (not depicted) in the storage 403 for further use during the in-use phase 200 as will be described below.

The training phase 100 hence terminates, and the present method for detecting phishing web pages proceeds to the in-use phase.

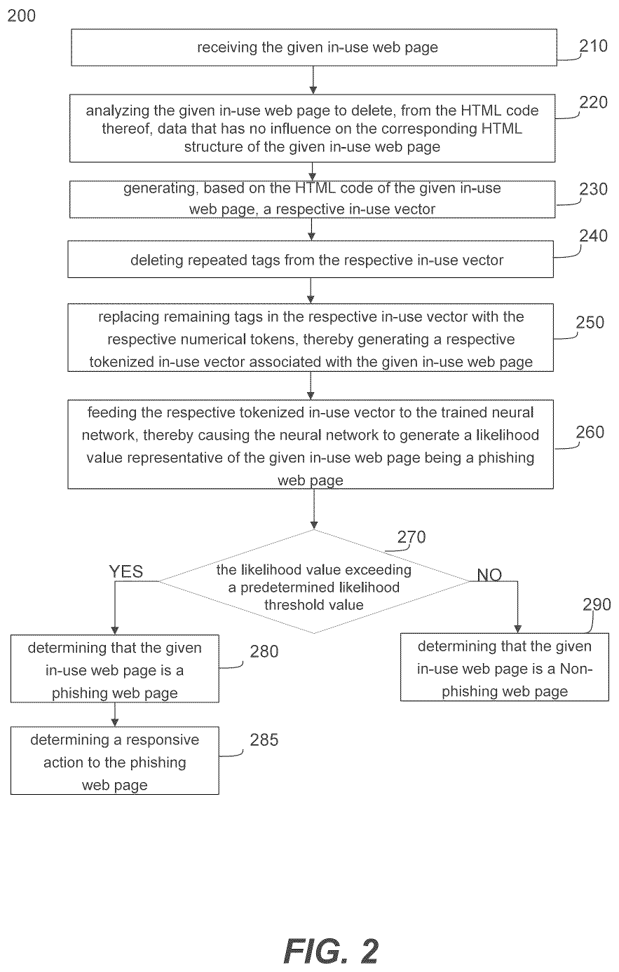

With reference to FIG. 2, there is depicted a flowchart diagram of an in-use phase 200 of the present method, in accordance with certain non-limiting embodiments of the present technology. Akin to the training phase 100, the in-use phase 200 can be executed by the processor 401 of the computing device.

Step 210: Receiving the Given in-Use Web Page

The in-use phase (200) commences at step (210) with the processor 401 being configured to receive the given in-use web page for further analysis of the HTML code thereof. The given in-use web page may come from a third-party information security system that utilizes a system that implements the present method to check whether the given in-use web page is a phishing web page. Alternatively, the given in-use web page may be directed to the system that implements the present method by a script that operates in a window of an Internet browser and that is intended to warn an Internet user against visiting phishing web pages. In some non-limiting embodiments of the present technology, the given in-use web page is fed to the system that implements the present method from a database of in-use (otherwise unanalyzed) web pages, where they have been preliminarily stored in order to determine whether they are phishing web pages or not.

The processor 401 can be configured to save the received given in-use web page in the storage 403.

The in-use phase 200 hence advances to step 220.

Step 220: Analyzing the Given in-Use Web Page to Delete, from the HTML Code Thereof, Data that has No Influence on the Corresponding HTML Structure of the Given in-Use Web Page

At step (220), the processor 401 can be configured to delete, from the HTML code of the given in-use web page, data that has no influence on the HTML structure from the HTML code of the given in-use web page. This step is performed similar to how step (120) of the training phase 100 is performed, as described above with reference to FIG. 3A. Similarly, the processor 401 can be configured to: (i) generate an in-use refined HTML code of the given in-use web page; and (ii) store the in-use refined HTML code in the storage 403.

The in-use phase 200 hence advances to step 230.

Step 230: Generating, Based on the HTML Code of the Given in-Use Web Page, a Respective in-Use Vector

At step (230), akin to step 130 of the training phase 100, as described above with reference to FIG. 3B, the processor 401 can be configured to generate, based on the refined in-use HTML code, an in-use vector for the given in-use web page.

The in-use phase 200 hence advances to step 240.

Step 240: Deleting Repeated Tags from the Respective in-Use Vector

At step (240), similar to step 140 of the training phase 100, as described above with reference to FIGS. 3C and 3D, the processor 401 can be configured to delete repeated tags from the in-use vector associated with the given in-use web page, thereby generating a refined in-use vector. Further, the processor 401 can be configured to store the refined in-use vector in the storage 403.

The in-use phase 200 hence advances to step 250.

Step 250: Replacing Remaining Tags in the Respective in-Use Vector with the Respective Numerical Tokens, Thereby Generating a Respective Tokenized in-Use Vector Associated with the Given in-Use Web Page

At step (250), akin to step 150 of the training phase 100, as described above with reference to FIGS. 3D and 3E, the processor 401 can be configured to replace the remaining tags in the refined in-use vector of the given in-use web page with respective numerical tokens. By doing so, the processor 401 is configured to generate a tokenized in-use vector for the given in-use web page. The processor 401 can further be configured to store the tokenized in-use vector in the storage 403.

According to certain non-limiting embodiments of the present technology, after generating and storing the tokenized in-use vector, the in-use phase 200 proceeds to step 260.

However, in some non-limiting embodiments of the present technology, after generating the tokenized in-use vector, at step 250, the processor 401 can optionally further be configured to determine the respective value of the similarity metric between the tokenized in-use vector of the given in-use web page and each of the tokenized vectors that correspond to the training phishing web pages from the refined plurality of training digital objects stored in the separate database that has been generated as described above at step 170. Akin to the difference metric mentioned above at step 170 of the training phase 100, the similarity metric can be based on one of: a cosine similarity, a Levenshtein distance, and a Damerau-Levenshtein distance. The processor 401 can be configured to determine respective values of the similarity metric between the tokenized in-use vector that corresponds to the given in-use web page and each of the tokenized training vectors that correspond to the training phishing web pages of the plurality of training web page used for training the neural network during the training phase 100.

Further, the processor 401 can be configured to determine a phishing training web page whose tokenized training vector is associated with a maximum respective value of the similarity metric relative to the tokenized in-use vector of the given in-use web page. In other words, based on the respective values of the similarity metric, the processor 401 can be configured to identify the training phishing web page that is most similar to the given in-use web page.

For example, upon analysis of the given in-use web page if it indeed were a phishing web page, the processor 401 might be configured to determine the following values of the similarity metric:

Phishing_page_451.html 0.91.

Phishing_page_985.html 0.19

Phishing_page_1247.html 0.02

. . . (1)

Thus, in the example (1), the maximum value of the similarity metric of 0.91 will be chosen.

In alternative non-limiting embodiments of the present technology, upon analysis of the given in-use web page if it indeed were a non-phishing web page, the following values might be obtained at the step (260):

Phishing_page_774.html 0.02.

Phishing_page_7432.html 0.01

Phishing_page_167.html 0.01

. . . (2)

Thus, in the example (2), the greatest value of the similarity metric of 0.02 will be chosen.

Further, according to certain non-limiting embodiments of the present technology, the processor 401 can be configured to compare the greatest value of the similarity metric to a second predetermined difference value threshold. For example, the second predetermined difference value threshold be 0.7. In response to determining that the greatest value of the similarity metric associated with the given in-use web page is greater than predetermined difference value threshold, the processor 401 can be configured to determine that the given in-use web page is a phishing web page.

By doing so, the present method may allow saving time and computational resources of the computing environment 400 during mass checking of the in-use web pages. In other words, identifying phishing web page based on the values of the similarity metric described above can be executed much faster and can require far less computational resources than the execution of the trained neural network. Thus, the approach, directed to using the similarity metric, described above, may be used for more efficient detection of phishing web pages that are very similar to already known web pages without using computational power for the execution of the trained neural network.

Thus, in these embodiments where the processor 401 is configured to compare the tokenized in-use vector with tokenized vectors of the refined plurality of training digital objects, in response to the maximum value of the similarity metric associated with the given in-use web page exceeding the second predetermined difference threshold value, such as in the example (1), the in-use phase 200 proceeds to step (280) that will be described below in detail.

In contrast, if the maximum value of the similarity metric, e.g., such as in example (2), is lower than the second predetermined difference threshold value, i.e., the given in-use web page is not very similar to any of the known phishing web pages, then the in-use phase 200 proceeds to step (260).

Step 260: Feeding the Respective Tokenized in-Use Vector to the Trained Neural Network, Thereby Causing the Neural Network to Generate a Likelihood Value Representative of the Given in-Use Web Page being a Phishing Web Page

At step 260, according to certain non-limiting embodiments of the present technology, the processor 401 can be configured to feed the in-use tokenized vector of the given in-use web page to the neural network that has been trained during the training phase 100. In response, the trained neural network can be configured to generate a respective likelihood value representative of the given in-use web page being phishing or not.

The in-use phase 200 hence advances to step 270.

### Step 270: The Likelihood Value Exceeding a Predetermined Likelihood Threshold Value

At step 270, the processor 401 can be configured to determine whether the respective likelihood value associated with the given in-use web page is greater than a predetermined likelihood threshold value, such as 0.87, as an example.

In response to determining that the respective likelihood value associated with the given in-use web page exceeds predetermined likelihood threshold value, the in-use phase 200 advances to steps 280 and 285.

Step 280: Determining that the Given in-Use Web Page is a Phishing Web Page

At step 280, if the respective likelihood value, generated by the neural network for the given in-use web page, exceeds the predetermined likelihood threshold value that has been initially set, e.g., 0.87, the processor 401 can be configured to determine that the given in-use web page received at step (110) is a phishing page.

The in-use phase 200 hence advances to step 285.

### Step 285: Determining a Responsive Action to the Phishing Web Page

In response to determining that the given in-use web page is a phishing web page, at step 285, according to certain non-limiting embodiments of the present technology, the processor can be configured to determine a responsive action to the phishing web page.

According to certain non-limiting embodiments of the present technology, the responsive action to the detected phishing web page can include at least one of:
compiling and sending a complaint to a hosting provider associated with the phishing web page;
compiling and sending a complaint to a domain registrar associated with the phishing web page;
compiling a warning notification to cybersecurity personnel;
outputting, in a browser window executed by the computing device, a warning notification that the given in-use web page is the phishing page; and
storing the phishing web page in a database of phishing pages.

Further, the processor 401 can be configured dot cause execution of the responsive action. After the responsive action to the phishing web page is completed, the in-use phase 200 may return to step (210) for analyzing another in-use web page for phishing.

However, if the respective likelihood value generated by the trained neural network for the given in-use web page does not exceed the predetermined likelihood threshold value, the in-use phase 200 advances to step 290.

Step 290: Determining that the Given in-Use Web Page is a Non-Phishing Web Page

In contrast, if respective likelihood value generated by the trained neural network for the given in-use web page is lower than or equal to the predetermined likelihood threshold value, the processor 401 can be configured to determine that the given in-use web page is a non-phishing, secure, web page. Further, the in-use phase 200 can return to step 210 for analyzing another in-use web page for phishing.

The in-use phase 200 and the present method hence terminate.

### Computing Environment

With reference to FIG. 4, there is depicted an example functional diagram of the computing environment 400 configurable to implement certain non-limiting embodiments of the present technology including the training and in-use phases 100, 200 of the present method, described above.

In some non-limiting embodiments of the present technology, the computing environment 400 may include: the processor 401 comprising one or more central processing units (CPUs), at least one non-transitory computer-readable memory 402 (RAM), the storage 403, input/output interfaces 404, input/output means 405, data communication means 406.

According to some non-limiting embodiments of the present technology, the processor 401 may be configured to execute specific program instructions the computations as required for the computing environment 400 to function properly or to ensure the functioning of one or more of its components. The processor 401 may further be configured to execute specific machine-readable instructions stored in the at least one non-transitory computer-readable memory 402, for example, those causing the computing environment 400 to execute the training and in-use phases 100, 200 of the present method, as an example.

In some non-limiting embodiments of the present technology, the machine-readable instructions representative of software components of disclosed systems may be implemented using any programming language or scripts, such as C, C++, C#, Java, JavaScript, VBScript, Macromedia Cold Fusion, COBOL, Microsoft Active Server Pages, Assembly, Perl, PHP, AWK, Python, Visual Basic, SQL Stored Procedures, PL/SQL, any UNIX shell scrips or XML. Various algorithms are implemented with any combination of the data structures, objects, processes, procedures and other software elements.

The at least one non-transitory computer-readable memory 402 may be implemented as RAM and contains the necessary program logic to provide the requisite functionality.

The storage 403 may be implemented as at least one of an HDD drive, an SSD drive, a RAID array, a network storage, a flash memory, an optical drive (such as CD, DVD, MD, Blu-ray), etc. The storage 403 may be configured for long-term storage of various data, e.g., the aforementioned documents with user data sets, databases with the time intervals measured for each user, user IDs, etc.

The input/output interfaces 404 may comprise various interfaces, such as at least one of USB, RS232, RJ45, LPT, COM, HDMI, PS/2, Lightning, FireWire, etc.

The input/output means 405 may include at least one of a keyboard, a joystick, a (touchscreen) display, a projector, a touchpad, a mouse, a trackball, a stylus, speakers, a microphone, and the like. A communication link between each one of the input/output means 405 can be wired (for example, connecting the keyboard via a PS/2 or USB port on the chassis of the desktop PC) or wireless (for example, via a wireless link, e.g., radio link, to the base station which is directly connected to the PC, e.g., to a USB port).

The data communication means 406 may be selected based on a particular implementation of a network, to which the computing environment 400 can have access, and may comprise at least one of: an Ethernet card, a WLAN/Wi-Fi adapter, a Bluetooth adapter, a BLE adapter, an NFC adapter, an IrDa, a RFID adapter, a GSM modem, and the like. As such, the connectivity hardware 404 may be configured for wired and wireless data transmission, via one of a WAN, a PAN, a LAN, an Intranet, the Internet, a WLAN, a WMAN, or a GSM network, as an example.

These and other components of the computing device 400 may be linked together using a common data bus 410.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to provide certain examples of implementation of the non-limiting embodiments of the present technology rather than to be limiting. The scope of the present technology is therefore intended to be limited solely by the scope of the appended claims.

1. A computer-implemented method for detecting phishing web pages, the method being executable by a computing device including at least one processor, the method comprising:
during a training phase:
receiving a plurality of training web pages;
analyzing each one of the plurality of training web pages to delete, from a Hypertext Markup Language (HTML) code thereof, data that has no influence on a corresponding HTML structure of the plurality of training web pages;
generating, based on the HTML code of a given training web page of the plurality of training web pages, a respective training vector,
the respective training vector including a plurality of tags defining the corresponding HTML structure of the given training web page;
deleting repeated tags from the respective training vector associated with the given training web page;
replacing remaining tags in the respective training vector with respective numerical tokens, thereby generating a respective tokenized training vector associated with the given training web page;
generating a training set of data including a plurality of training digital objects, a given one of which includes: (i) the respective tokenized training vector associated with the given training web page; and (ii) a respective label representative of whether the given training web page is a phishing web page or not;
feeding each one of the plurality of training digital objects to a neural network for training the neural network to determine whether a given in-use web page is a phishing web page or not;
during an in-use phase, following the training phase:
receiving the given in-use web page;
analyzing the given in-use web page to delete, from the HTML code thereof, data that has no influence on the corresponding HTML structure of the given in-use web page;
generating, based on the HTML code of the given in-use web page, a respective in-use vector;
deleting repeated tags from the respective in-use vector;
replacing remaining tags in the respective in-use vector with the respective numerical tokens, thereby generating a respective tokenized in-use vector associated with the given in-use web page;
feeding the respective tokenized in-use vector to the trained neural network, thereby causing the neural network to generate a likelihood value representative of the given in-use web page being a phishing web page; and
in response to the likelihood value exceeding a predetermined likelihood threshold value:
determining that the given in-use web page is a phishing web page; and
determining a responsive action to the phishing web page.

2. The method of claim 1, wherein the data that has no influence on the HTML structure includes at least one selected from the group consisting of:
mandatory tags that are present in the HTML code of every web page;
metadata including content of the given training web page that is not represented by the HTML code;
attributes including additional parameters that are arranged within angle brackets; and
embedded tags.

3. The method of claim 1, wherein each numerical token is an integer number.

4. The method of claim 1, wherein during the training phase, the method further comprises:
determining, for each tokenized training vector of a respective phishing training web page of the plurality of training web pages, a respective value of a difference metric from respective tokenized training vectors of non-phishing training web pages of the plurality of training pages;
identifying, among tokenized training vectors of phishing training web page, based on respective values of the difference metric, unstable tokenized training vectors; and
removing, from the plurality of training digital objects, training digital objects including the unstable tokenized training vectors, thereby generating a refined plurality of training digital objects.

5. The method of claim 4, wherein the identifying the unstable tokenized training vectors comprises identifying those tokenized training vectors of phishing training web pages of the plurality of training webpages that are associated with respective values of the difference metric that are no greater than a predetermined difference threshold value.

6. The method of claim 4, wherein the difference metric is based on a cosine similarity.

7. The method of claim 4, wherein the difference metric is based on a Levenshtein distance.

8. The method of claim 4, wherein the difference metric is based on a Damerau-Levenshtein distance.

9. The method of claim 4, wherein during the in-use phase, prior to the feeding the respective tokenized in-use vector to the trained neural network, the method further comprises:
determining a respective value of a similarity metric between the respective tokenized in-use vector and each training tokenized vector in the refined plurality of training digital objects; and
in response to a maximum value among respective values of the similarity metric exceeding a predetermined similarity threshold value, determining that the given in-use web page is a phishing web page.

10. The method of claim 9, wherein the similarity metric is based on one selected from the group consisting of: a cosine similarity, a Levenshtein distance, and a Damerau-Levenshtein distance.

11. The method of claim 1, wherein the neural network is a Long Short-Term Memory (LSTM) neural network.

12. The method of claim 1, wherein the neural network is a Gated Recurrent Unit (GRU) neural network.

13. The method of claim 1, wherein the responsive action to the phishing web page includes at least one selected from the group consisting of:
compiling and sending a complaint to a hosting provider associated with the phishing web page;
compiling and sending a complaint to a domain registrar associated with the phishing web page;
compiling a warning notification to cybersecurity personnel;
outputting, in a browser window executed by the computing device, a warning notification that the given in-use web page is the phishing page; and
storing the phishing web page in a database of phishing pages.

14. A computing device for detecting of phishing web pages, the computing device comprising at least one processor and at least one non-transitory computer-readable medium storing instructions, which, when executed by the at least one processor, cause the computing device to execute:
during a training phase:
receiving a plurality of training web pages;
analyzing each one of the plurality of training web pages to delete, from a Hypertext Markup Language (HTML) code thereof, data that has no influence on a corresponding HTML structure of the plurality of training web pages;
generating, based on the HTML code of a given training web page of the plurality of training web pages, a respective training vector,
the respective training vector including a plurality of tags defining the corresponding HTML structure of the given training web page;
deleting repeated tags from the respective training vector associated with the given training web page;
replacing remaining tags in the respective training vector with respective numerical tokens, thereby generating a respective tokenized training vector associated with the given training web page;
generating a training set of data including a plurality of training digital objects, a given one of which includes: (i) the respective tokenized training vector associated with the given training web page; and (ii) a respective label representative of whether the given training web page is a phishing web page or not;
feeding each one of the plurality of training digital objects to a neural network for training the neural network to determine whether a given in-use web page is a phishing web page or not;
during an in-use phase, following the training phase:
receiving the given in-use web page;
analyzing the given in-use web page to delete, from the HTML code thereof, data that has no influence on the corresponding HTML structure of the given in-use web page;
generating, based on the HTML code of the given in-use web page, a respective in-use vector;
deleting repeated tags from the respective in-use vector;
replacing remaining tags in the respective in-use vector with the respective numerical tokens, thereby generating a respective tokenized in-use vector associated with the given in-use web page;
feeding the respective tokenized in-use vector to the trained neural network, thereby causing the neural network to generate a likelihood value representative of the given in-use web page being a phishing web page; and
in response to the likelihood value exceeding a predetermined likelihood threshold value:
determining that the given in-use web page is a phishing web page; and
determining a responsive action to the phishing web page.

15. The computing device of claim 14, wherein the instructions further cause the computing device to execute:
determining, for each tokenized training vector of a respective phishing training web page of the plurality of training web pages, a respective value of a difference metric from respective tokenized training vectors of non-phishing training web pages of the plurality of training pages;
identifying, among tokenized training vectors of phishing training web page, based on respective values of the difference metric, unstable tokenized training vectors; and
removing, from the plurality of training digital objects, training digital objects including the unstable tokenized training vectors.
